(19) United States
(12) Patent Application Publication
(10) Pub. No.: US 2006/0272894 A1
(43) Pub. Date: Dec. 7, 2006

(54) Ladder stabilizer

(76) Inventors: Jerry Hein, Oxnard, CA (US); Manuel George, Torrance, CA (US); Gerard Reposa, Harbor City, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/145,090

(22) Filed: Jun. 3, 2005

(51) Int. Cl. E06C 7/42

(52) U.S. Cl. 182/107

(57) ABSTRACT

A device for stabilizing a ladder has a clamp adapted to engage a side rail of the ladder, an arm extending from the clamp and a screw member disposed at the end of the arm. The ladder is leaned against the roof in the conventional manner and the device is positioned on the side rail of the ladder with the arm extending under the eaves. The screw member is then tightened against the underside of the roof (or against the soffit if there is one) to secure the ladder in position.

### BACKGROUND OF THE INVENTION

1. Field of the Invention

This invention relates to a device for stabilizing a ladder used to provide access to the roof of a structure. More specifically, the invention relates to a device that engages the eaves of a roof and secures the ladder in position.

2. Background

Ascending a ladder to the roof of a structure is inherently dangerous. Typically, the ladder is leaned against the edge of a roof, which may not provide adequate stability. If not secured in some fashion, the ladder may fall to one side or may fall backward away from the roof. A number of inventions have been proposed to address this problem. Quite a few patents have been issued for devices intended to stabilize a ladder. These include, for example:

| Patent Number | Inventor(s) | Issue Date |
|---|---|---|
| 783,259 | Friend | Feb. 21, 1905 |
| 1,467,597 | Wendel | Sep. 11, 1923 |
| 2,815,160 | Gilmour et al. | Dec. 3, 1957 |
| 4,823,912 | Gould et al. | Apr. 25, 1989 |
| 4,949,810 | Dwinnell | Aug. 21, 1990 |
| 5,012,895 | Santos | May 7, 1991 |
| 5,067,588 | Bendickson | Nov. 26, 1991 |
| 5,117,941 | Gruber | Jun. 2, 1992 |
| 5,165,501 | Donahey | Nov. 24, 1992 |
| 5,180,032 | Hidalgo | Jan. 19, 1993 |
| 5,383,533 | Nikula et al. | Jan. 24, 1995 |
| 5,509,500 | Delagera | Apr. 23, 1996 |
| 5,743,356 | Mitchell | Apr. 28, 1998 |
| 5,775,465 | Vossler | Jul. 7, 1998 |
| 5,971,100 | DeLeon et al. | Oct. 26, 1999 |
| 6,009,974 | Jones | Jan. 4, 2000 |
| 6,012,546 | Bee et al. | Jan. 11, 2000 |
| 6,019,191 | Flores | Feb. 1, 2000 |
| 6,045,102 | Terenzoni | Apr. 4, 2000 |
| 6,394,229 | Hastreiter | May 28, 2002 |
| 6,412,600 | Wolfman | Jul. 2, 2002 |
| 6,427,803 | Moore | Aug. 6, 2002 |
| 6,513,625 | Gaskins | Feb. 4, 2003 |
| 6,578,665 | DeBaca et al. | Jun. 17, 2003 |

### SUMMARY OF THE INVENTION

The present invention is directed to a device for stabilizing a ladder. In one embodiment the device comprises a clamp adapted to engage a side rail of the ladder, an arm extending from the clamp and a screw member disposed at the end of the arm. The ladder is leaned against the roof in the conventional manner and the device is positioned on the side rail of the ladder with the arm extending under the eaves. The screw member is then tightened against the underside of the roof (or against the soffit if there is one) to secure the ladder in position.

In another embodiment, a ladder stabilizer is configured as a strap that may be wrapped around the side rails of a ladder and nailed to a roof. The strap has fittings at each end that facilitate coupling two or more straps together end to end.

### BRIEF DESCRIPTION OF THE DRAWINGS

FIG. 1 is a perspective view showing a ladder stabilizer in accordance with the present invention.

FIG. 2 is a diagrammatic view showing the device in use to stabilize a ladder against a roof.

FIG. 3 illustrates a strap device for stabilizing a ladder.

FIG. 4 is a perspective view of an end fitting for the strap shown in FIG. 3.

FIG. 5 is a plan view of the end fitting shown in FIG. 4.

FIG. 6 is a partial cross-sectional view through line 6-6 of FIG. 5.

FIG. 7 illustrates another strap device for stabilizing a ladder.

FIG. 8 is a detailed view of the strap assembly shown in FIG. 7.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

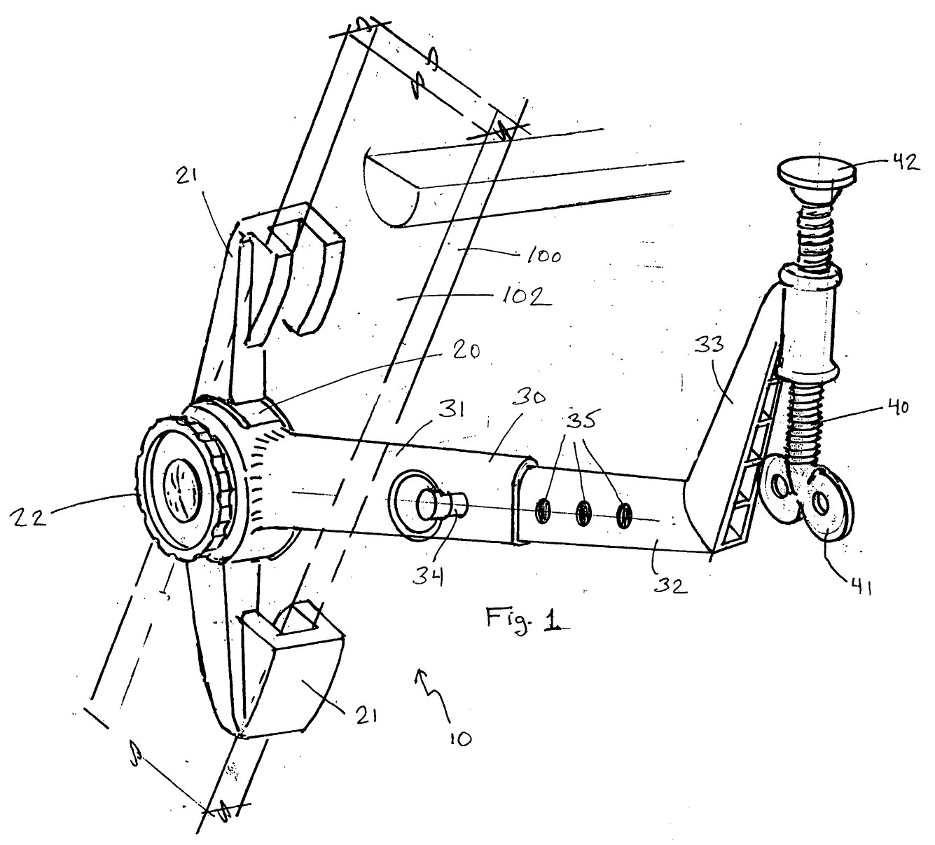

FIG. 1 shows a ladder stabilizer 10 in accordance with the present invention. The stabilizer comprises a clamp portion 20, an arm 30 extending from the clamp portion and a screw 40. Clamp portion 20 includes a pair of grips 21 that are slotted to engage rail 102 of ladder 100.

The length of arm 30 is preferably adjustable. To facilitate this, arm 30 comprises an outer section 31 and an inner telescoping section 32. A pin 34 engages one of a plurality of holes 35 to secure the telescoping sections together at a desired length. An upward reaching section 33 extends from the end of inner section 32. Screw 40 is threaded through section 33. Screw 40 has a handle portion 41 at its lower end and a foot potion 42 at its upper end.

Various materials are suitable for the construction of ladder stabilizer 10. The principal components could be constructed of steel or aluminum or a combination of the two materials. For reasons of economy and versatility, plastic is a preferred material.

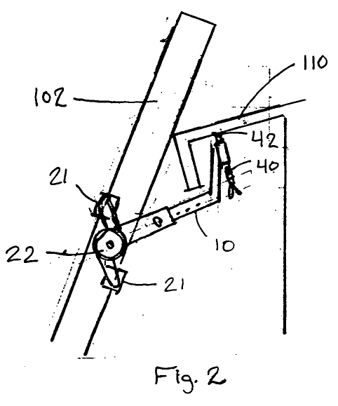

With reference now to FIG. 2, the use of ladder stabilizer 10 may be better understood. Rails 102 of a ladder 100 are leaned against the edge of roof 110. As mentioned above, the grips 21 of clamp 20 are adapted to engage rail 102. The angle between arm 30 and clamp 20 may be adjusted by means of adjustment knob 22 to accommodate different roof overhangs, gutters and fascia dimensions. Once the angle of arm 30 has been adjusted, screw 40 is tightened by means of handle 41 until the foot 42 engages the underside of the roof. It will be appreciated that tightening the screw 40 exerts a downward force on arm 30, which, in turn, applies a clockwise force on clamp 20 to more tightly engage ladder rail 102. This also forces the ladder against the edge of the roof to firmly secure it in place. Preferably, a stabilizer is used on each of the ladder rails for maximum stabilizing effect.

It should be noted that stabilizer 10 may also be used with a “parapet” style roof. In this case, the stabilizer is simply inverted and the screw member is tightened against the top of the parapet.

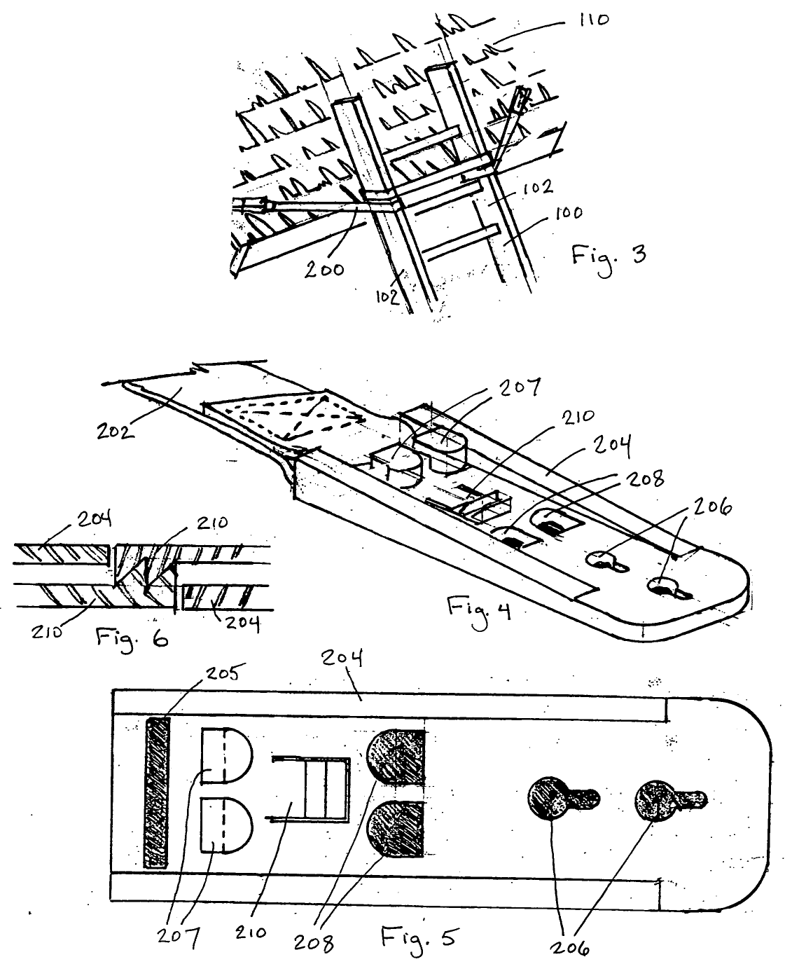

FIGS. 3-6 show a strap 200 for stabilizing ladder 100 against the edge of roof 110. The strap may be simply wrapped around the side rails 102 of the ladder and nailed to the roof at each end.

The construction of strap 200 can be better seen in FIGS. 4 and 5. The strap comprises a length of flexible material 202, such as nylon webbing. An end fitting 204 is secured at each end of the strap. Material 202 is looped through a slot 205 in the end fitting and sewn together. Nail holes 206 are provided for securing the ends of the strap to a roof.

A feature of strap 200 is the provision of means for coupling together two or more of the straps end to end. End fittings 204 have a pair of locking prongs 207 and a pair of locking prong holes 208. The holes are configured to receive the locking prongs of another end fitting that has been inverted and aligned with the first fitting. The locking prong holes 208 of each end fitting receive the locking prongs 207 of the other end fitting. The locking prongs are shaped so that, once the two end fittings have been placed together, the locking prongs extend over the surface of the adjacent end fitting to secure them together.

Each of end fittings 204 is provided with a safety clip 210 to prevent unintended uncoupling of coupled end fittings. Safety clip 210 is separated from end fitting 204 on three sides so that it can deflect slightly from the plane of the fitting. The safely clip has a saw-tooth cross-section as illustrated in FIG. 6. When a pair of end fittings are coupled together, the opposing safety clips engage each other as the locking prongs are slid over the respective locking prong holes. This prevents the unintentional uncoupling of the end fittings since the safety clips must be manually separated before the locking prongs can be removed from their respective locking prong holes.

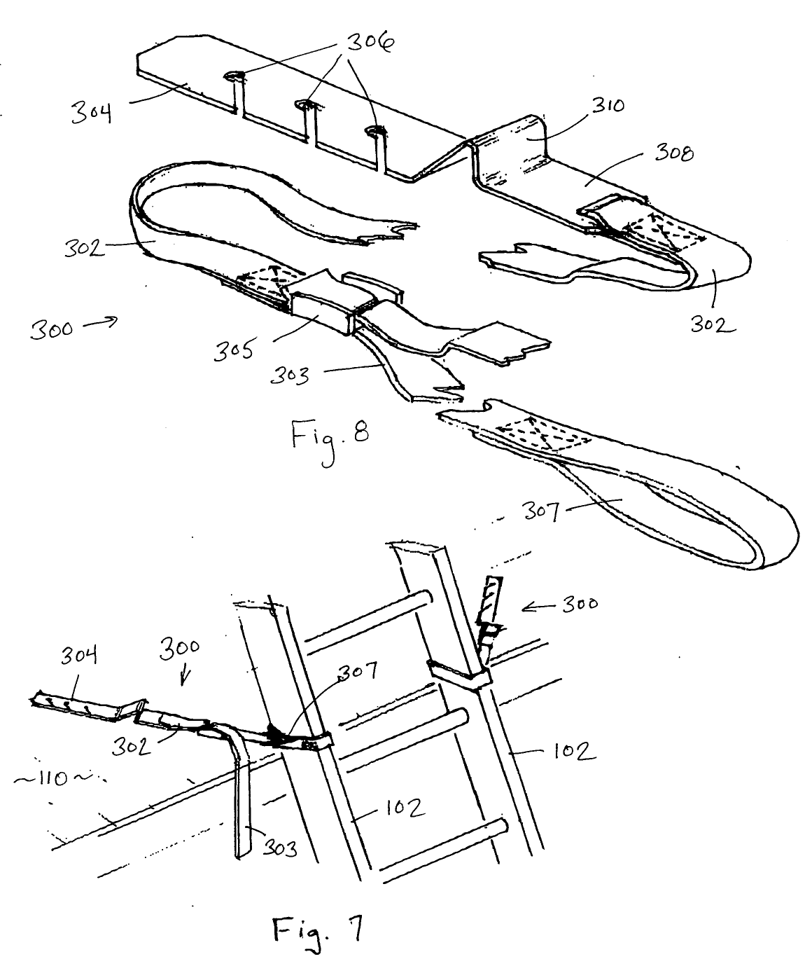

FIGS. 7 and 8 show another type of strap assembly 300 for stabilizing ladder 100 against the edge of roof 110. As shown, a pair of strap assemblies 300 are used, one with each of the side rails 102 of the ladder. The assembly comprises a first strap portion 302 secured at one end to end fitting 304 and at the other end to adjustment clamp 305. A second strap portion 303 is releasably secured by the adjustment clamp. Strap portions 302 and 303 may be made of nylon webbing as in the previously described embodiment.

Each of the strap assemblies is secured to the roof at end fitting 304 by nails driven through slotted holes 306. Strap portion 303 is wrapped around the respective side rail of ladder 100 and threaded through loop 307 like a slipknot in a lasso. The free end of strap portion 303 is then threaded through adjustment clamp 305 and secured taught.

End fitting 304 is formed with bends so that portion 308, which connects to strap portion 302, is raised off of the surface of the roof. The bends also provide an upright surface 310, which may be struck with a hammer to dislodge the end fitting from the securing nails. End fitting 304 is preferably made of metal strap material, such as steel, which is plated or otherwise treated for corrosion protection.

When ladder 100 is to be relocated, tension in the strap assemblies is released at the adjustment clamps, and the end fittings are tapped off of the nails and removed.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. A device for stabilizing a ladder comprising:
a clamp adapted to engage a side rail of a ladder;
an arm extending from the clamp;
a screw member disposed at an end of the arm remote from the clamp;
whereby a ladder may be stabilized against an edge of a roof by tightening the screw member against an underside of the roof.

2. The device of claim 1 wherein the arm is adjustable for length.

3. The device of claim 2 wherein the arm comprises inner and outer telescoping sections.

4. The device of claim 1 wherein the arm is rotatably connected to the clamp such that an angle between the arm and the clamp is adjustable.

5. The device of claim 4 further comprising means for adjusting the angle between the arm and the clamp.

6. A device for stabilizing a ladder comprising:
a clamp having a pair of grip portions for engaging a side rail of a ladder;
an arm extending from the clamp, the arm having inner and outer telescoping sections and an upward reaching section remote from the clamp;
a screw member disposed in the upward reaching section, the screw member having a handle portion at a lower end thereof and a foot portion at an upper end thereof;
whereby a ladder may be stabilized against an edge of a roof by tightening the screw member so that the foot portion engages an underside of the roof.

7. The device of claim 7 wherein the arm is rotatably connected to the clamp such that an angle between the arm and the clamp is adjustable.

8. The device of claim 7 further comprising means for adjusting the angle between the arm and the clamp.

9. A device for stabilizing a ladder comprising:
a first strap portion;
an end fitting secured to a first end of the first strap portion, the end fitting having at least one nail receiving hole;
a second strap portion having a loop at one end thereof;
an adjustment clamp secured to a second end of the first strap portion and adapted to receive the second strap portion.

10. The device of claim 9 wherein the end fitting has a substantially planar first surface surrounding the nail receiving hole and a second surface substantially perpendicular to the first surface.

11. The device of claim 10 wherein the nail receiving hole includes a slot extending through an edge of the first surface.

12. The device of claim 10 wherein the end fitting is configured as a folded length of metal strap.
